(19) United States
(12) Patent Application Publication
(10) Pub. No.: US 2010/0000931 A1
(43) Pub. Date: Jan. 7, 2010

(54) POTABLE LIQUID DISPENSER

(76) Inventor: Janet Castillo, Martinez, GA (US)

Correspondence Address: HAHN LOESER & PARKS, LLP, One GOJO Plaza, Suite 300, AKRON, OH, 44311-1076, US

(21) Appl. No.: 12/166,006

(22) Filed: Jul. 1, 2008

(51) Int. Cl. B01D 24/00; B01D 15/02; B67D 7/76

(52) U.S. Cl. 210/266; 222/189.06; 210/232; 210/264

(57) ABSTRACT

A potable liquid dispensing apparatus includes a housing configured to be coupled to a source of potable liquid. A filter is disposed within the housing for the passage of the potable liquid.

### BACKGROUND

This invention relates in general to potable liquid dispensers, such as drinking water dispensers, and the like.

Drinking water dispensers are provided with water bottles or water jugs, or are connected to a separate source of liquid, such as by water supply lines. Often these water dispensers are capable of performing one or more auxiliary functions, such as heating or cooling the liquid to be dispensed.

Presently, in the case of bottled water dispensers, consumers are not necessarily confident that water from a bottle is necessarily of a differing quality than tap water. Additionally, there are concerns with regards to the use and disposal of water bottles, such as the amount of oil used in manufacturing these bottles, the time-cost and the consumption of fuel involved in the refill and/or delivery of new or used bottles, and the quantity of bottles that end up in the landfills or otherwise polluting the environment.

### SUMMARY

This invention relates to an improved potable liquid dispenser.

A potable liquid dispenser includes a housing configured to be coupled to a source of potable liquid. A filter is disposed within the housing for the passage of the potable liquid. The housing may be placed upon an optional base to support the housing.

In one embodiment, a refillable reservoir engages the housing to supply the potable liquid. In another embodiment, a supply line is connected to the housing to supply the potable liquid. In a further embodiment, liquid is poured directly into a basin of the housing.

In one embodiment, the filter is suitable to be disposed in the basin of a variety of housings and has a coupling that may engage a variety of bottles or jugs. In another embodiment, the filter is part of a cassette and disposed within a cassette receiver.

Various aspects will become apparent from the following detailed description and accompanying drawings.

### BRIEF DESCRIPTION

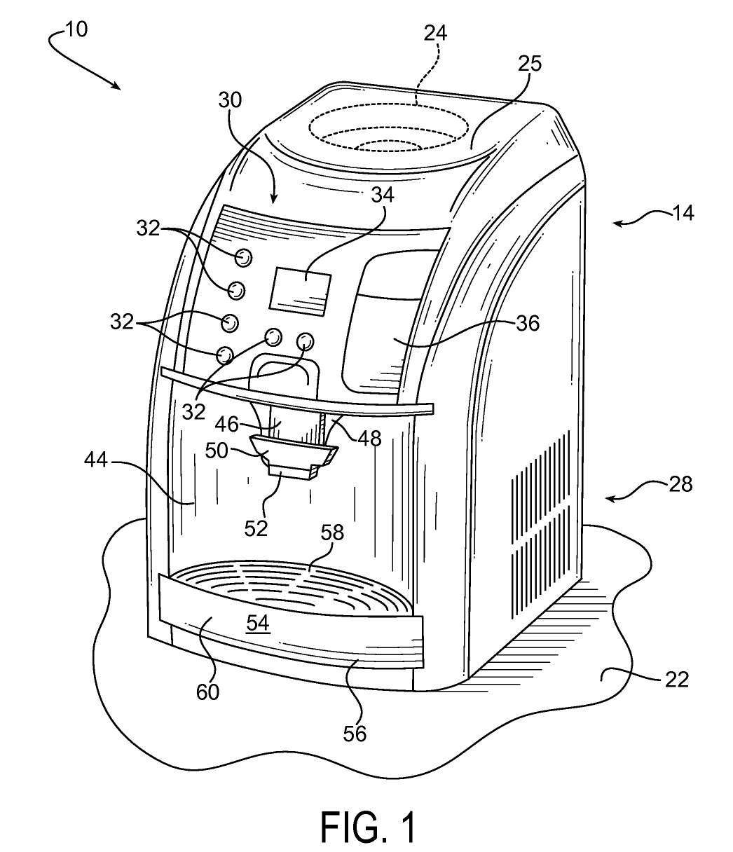

FIG. 1 is a front perspective view of a potable liquid dispenser according to the concepts of the present invention.

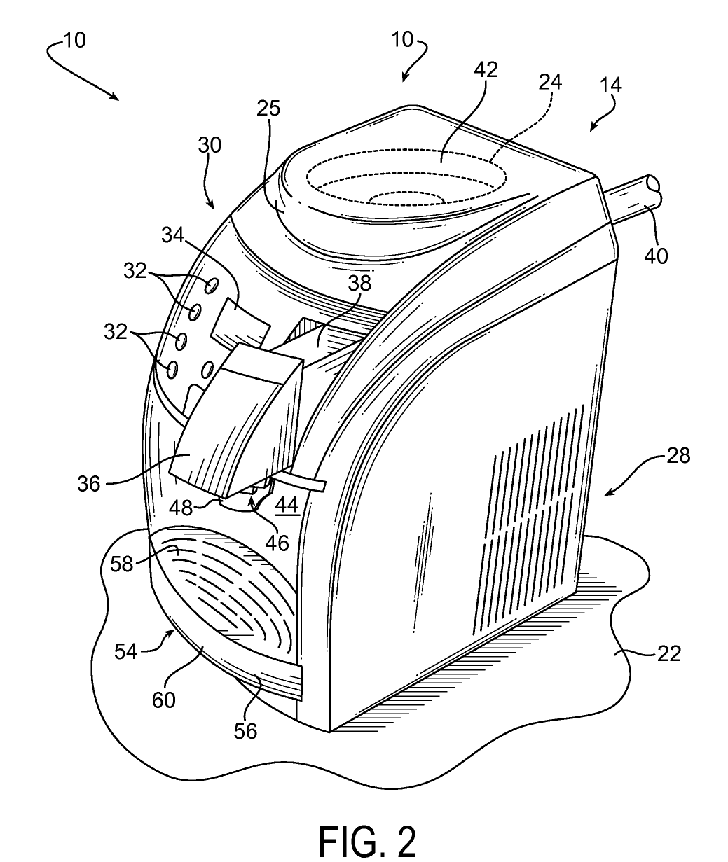

FIG. 2 is an angled perspective view of the dispenser showing the cassette receiver and filter cassette in an extended position.

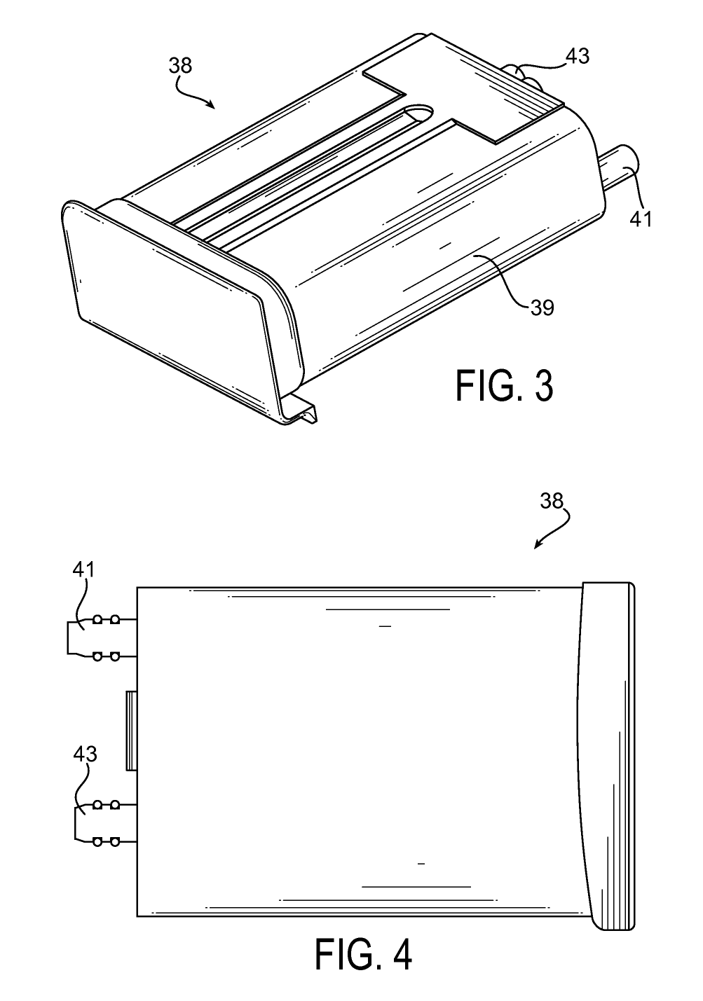

FIG. 3 is an angled perspective view of the filter cassette.

FIG. 4 is a side view of the filter cassette.

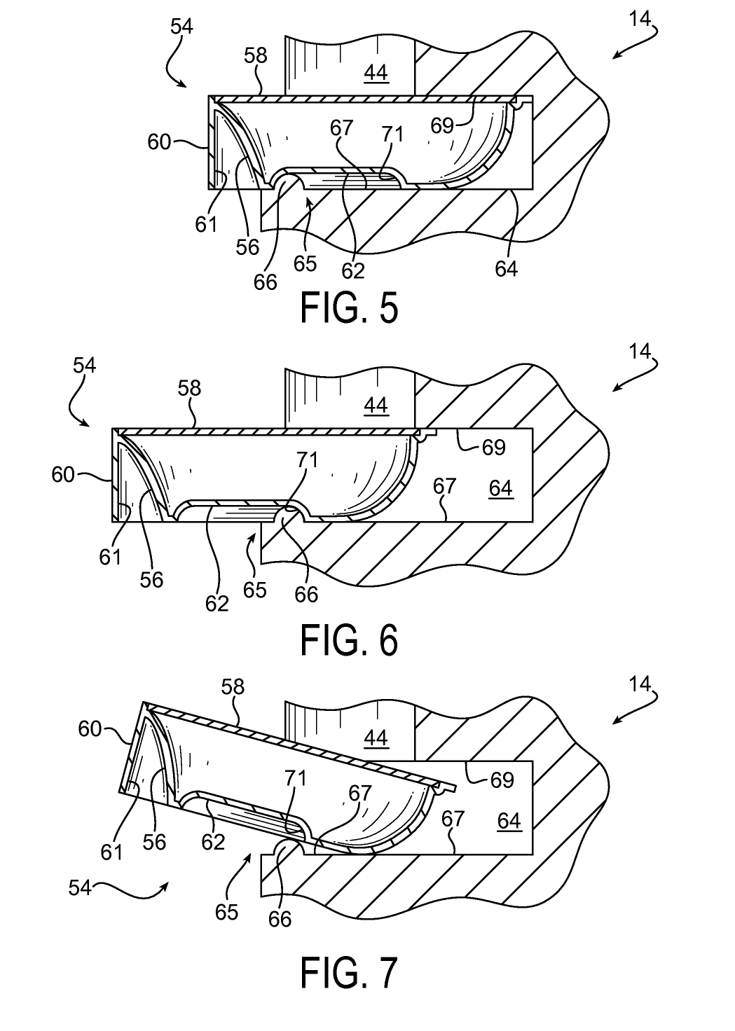

FIG. 5 is a fragmented sectional side view of the dispenser showing a sump platform in a partially retracted position.

FIG. 6 is a view similar to FIG. 4 showing the sump platform in an extended position.

FIG. 7 is a view similar to FIGS. 3 and 4 showing removal of the sump platform.

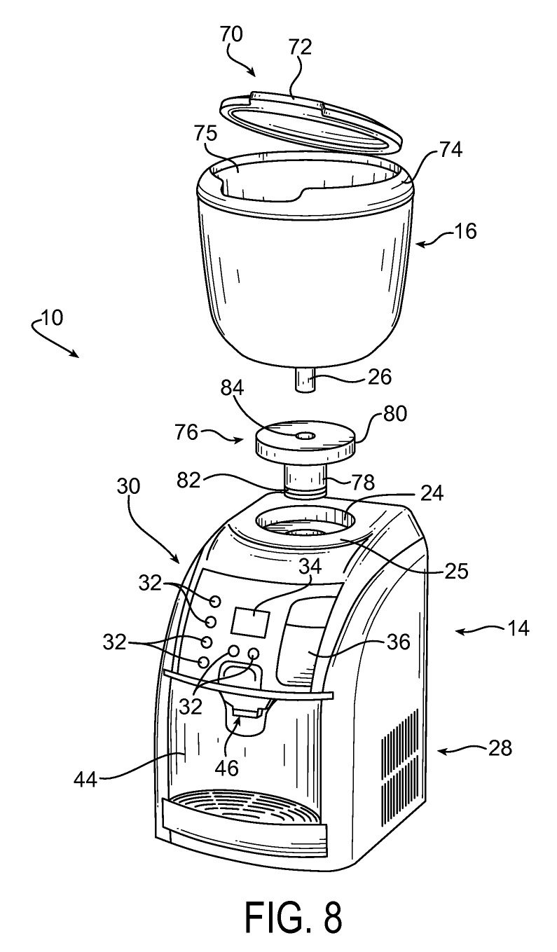

FIG. 8 is an exploded view of a dispenser having an optional basin filter and reservoir.

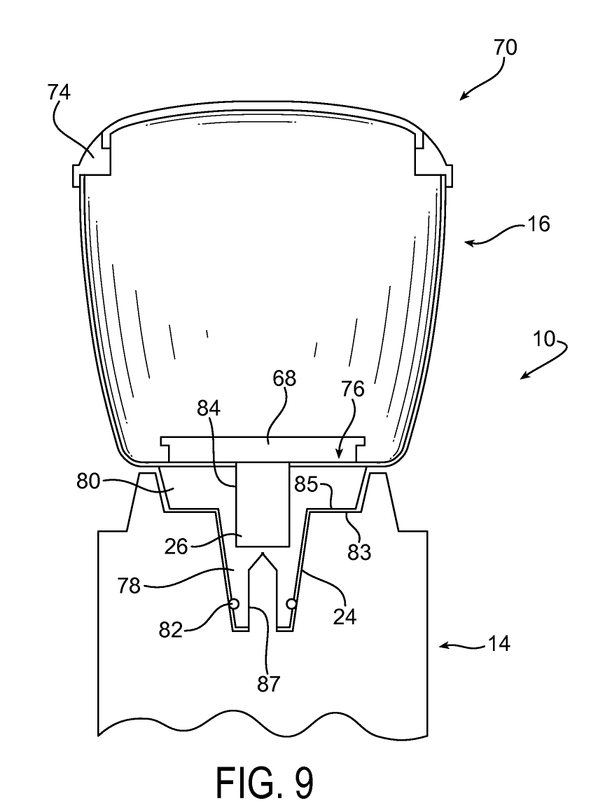

FIG. 9 is a cross-sectional view similar to FIG. 7 depicting the dispenser in an assembled arrangement.

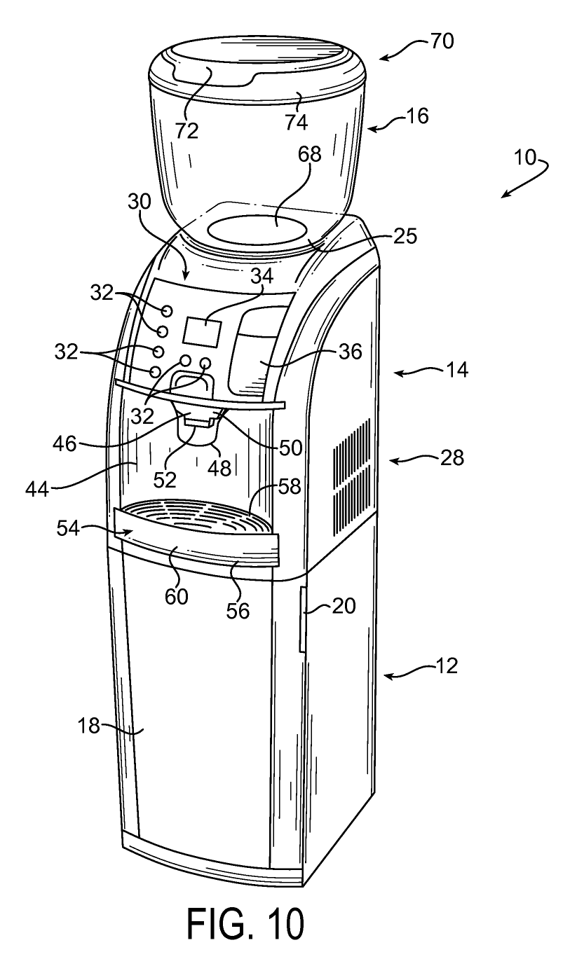

FIG. 10 is an angled perspective view of a dispenser having an optional base.

### DETAILED DESCRIPTION

Referring now to the drawings, a potable liquid dispenser is generally indicated by the number 10. The following description may refer to particular potable liquids, such as drinking water; however, it must be understood that the dispenser 10 may dispense any potable liquid. Additionally, the following description may refer to any number of treatments for the liquid being dispensed, such as fortifying, filtering, heating, or cooling; however, it must be understood that any liquid may being dispensed may be treated in any suitable manner, or not treated at all.

As shown in FIG. 1, dispenser 10 includes a housing 14. The housing 14 may be made of any suitable material, such as metal, for example stainless steel, or plastic, for example a high density plastic, or wood, glass or any suitable composite material, and may be colored in any desired color, in any suitable manner, such as painting or dying.

The housing 14 is shown in FIGS. 1 and 2 as a surface-top unit resting directly on a countertop or tabletop 22.

The housing 14 includes a basin 24 for receiving potable liquid, shown in dashed lines in FIGS. 1 and 2, and having an optional basin extension 25, the purpose of which will be described below. The basin is configured for receiving potable liquid from a potable liquid source such as a liquid supply line 40 or suitable liquid container, as will be described below. In one embodiment, as illustrated in FIG. 2, the housing 14 is coupled to a traditional water supply line 40. In such a case, an optional top-cover 42 is placed over the basin 24. Alternatively, potable liquid may be poured directly into the basin 24 or may be provided to the basin 24 by a liquid container.

The housing 14 may include any number of optional liquid treatment devices, such as heaters, coolers, filters or fortifiers, as will be further described below. In the case of heaters and coolers optional vents 28 are provided in the housing 14 to promote air flow.

The housing 14 includes an optional control panel 30 for controlling the functions of the housing 14. The control panel may include selectors 32, such as buttons, knobs, switches and the like, to control the dispensing of hot, tepid or cold water, select a preprogrammed function, access a control menu for the housing 14 and/or program a control unit. The selectors may be coded in any suitable manner, such as alpha numeric text or color coding, for example blue for cold and red for hot.

Additionally, the housing 14 includes an optional display 34. The display may indicate any condition of the liquid being dispensed, such as temperature or particle level, or may indicate any condition of the liquid from the supply source. Further, the display may be used an interface for control menu access and other similar functions. The display 34 may be any suitable display, such as an LED display, a back lit LCD. The display may be a digital or analog display as desired.

The housing 14 also includes an optional cassette receiver 36. The receiver 36 is shown in FIGS. 1 and 2 in a retracted functioning position and an extended access position in FIG. 3 with a cartridge or cassette unit 38 disposed therein. The cassette unit 38 may include a liquid treatment device 39, such as water filter or fortifier, as best shown in FIGS. 3 and 4. In the case of the fortifier, a fortifier may be used to provide vitamins, minerals and the like, or other additives such as preservative or flavoring. In the case of a filter, a filter may be provided that will remove lead, for example up to 98 percent of the lead present in the liquid, or as well reduce any one or more sedimentary material chlorine, copper, mercury, cadmium, and benzene, additionally the filter may function in any manner while leaving a desired level of fluoride, or other desired particles.

The cassette unit 38 may function in a gravity fed arrangement or may be coupled with a pump or pressure accumulator. The cassette unit 38 may be replaced as necessary by access in the extended position. In one embodiment, the cassette unit 38 may last up to three months or for passage of 80 gallons of potable liquid.

As shown in FIGS. 3 and 4, the cassette unit 38 includes an inlet port 41 and an outlet port 43. The ports 41 and 43 include sealing members, such as o-rings, to provide sealing arrangement is a liquid conveying system, such as plastic or metal liquid feed lines. In operation, potable liquid flow from the potable liquid source to the inlet port 41, through the treatment device 39, and from the outlet port 43 to be dispensed.

The housing 14 defines a nozzle recess 44. A movable nozzle 46 is disposed within the recess 44, shown extended in FIG. 1 and retracted in FIG. 2 (and FIG. 10). It must be understood that as used herein, the term “nozzle” in intended to indicate any fluid outlet of the housing and associated flow control. The recess 44 includes an optional contour 48 that generally indicates the range of movement of the nozzle 46. Movement of the nozzle 46 may be automatically actuated by a mechanism disposed within the housing 14 or manually by a user. In the case of the latter, the nozzle 46 includes an optional grip 50 that is formed for the grasp of a user. The nozzle 46 may also include an optional marker 52, in the form of a contrastingly colored or chrome tip, to alert a user to the user to the location and/or position of the nozzle 46 with high contrast between the marker 52 and the recess 44 disposed therebehind. In operation the height of the nozzle 46 may be adjusted to the height of a receptacle placed in the nozzle recess 44 for the reception of potable liquid. The height of the nozzle 46 may be adjusted to minimize the amount of splashing or turbulence created during dispensing of the potable liquid.

During operation the dispenser 10 may operate in a measured fill mode where a predetermined amount of liquid may be dispensed. For example, the control panel 30 may include buttons, or other selectors, that are associated with a predetermined amount of liquid to be dispensed, such as 8, 12, or 16 ozs. Alternatively, a user may select the type of container to be filled, such as a cup, mug or glass. The dispenser 10 may then dispense an appropriate volume of liquid accordingly. These different amounts may be designated by different icons on the control panel 30. Liquid dispensed in such a manner tends to avoid the creation of waste water from spillage or overfilling and frees the user from having to monitor the dispenser during filling of a container, thus freeing the user to conduct other activities during the fill operation.

As best shown in FIGS. 5-7, the housing 14 also includes an optional sump platform 54 having a sump tray 56 and a removable sump cover 58. The sump tray 56 resides below nozzle 46 and acts as a catch for liquid that drips or spills from nozzle 46 or a user's receptacle. The sump cover 58 is perforated to allow liquid to collect in the tray 56 while providing a support surface for a user's receptacle. Periodically, sump tray 56 may be removed to discard any liquid collected therein or to clean sump tray 56 or cover 58. To that end, sump tray 56 includes a handle 60 located at its forward end. A handle recess 61 may be formed in sump tray 56 behind handle 60 to allow insertion of the user's fingers to better grasp and manipulate sump tray 56.

To avoid inadvertent removal of sump tray 56, sump tray 56 may include a catch assembly, generally indicated by the number 65. Catch assembly 65 generally includes a stop that prevents sump tray 56 from sliding freely out of housing 14. In the example shown, housing 14 includes a protrusion 66 that acts as a stop, and sump tray 56 defines a recess or groove 62 that is disposed longitudinally along the tray 56 to receive protrusion 66. The housing recess 44 includes a sump recess 64, into which the sump platform 54 may extend. The protrusion 66 may extend upwardly from a lower surface 67 of sump recess 64 near the mouth of recess 64.

The sump platform 54 is shown in FIG. 5 in a nested or retracted position, in FIG. 6 in an extended position, and in FIG. 7 in a lifted position. In the retracted position, the sump platform is braced between lower and upper surfaces 67 and 69 of the sump recess 64. For removal, a user may grasp the handle 60 move the sump platform 54 to the extended position, where protrusion 66 engages a rearward stop portion 71 of groove 62, which will halt the forward movement of the sump platform 54 before being in a position where it would tip downwardly spilling the contents of sump tray 56. To remove sump tray 56, the user may lift or rotate the sump platform 54 to a lifted position (FIG. 7), where sump tray 56 clears protrusion 66, and pull sump platform 54 out of the housing 14.

With reference to FIGS. 8 and 9, a reservoir 16 may be used as a liquid source for housing 14. As shown, reservoir 16 may be supported by housing 14 and basin extension 25 may at least partially supports the reservoir 16. The reservoir 16 includes an outlet 26 for providing liquid to basin 24; the basin 24 being operable to receiving liquid from the outlet 26 of the reservoir 16. The reservoir 16 may be made of any suitable material; however the use of transparent material allows a user to clearly see the level of liquid within the reservoir 16. In the example shown, reservoir 16 is made of a transparent plastic material. The reservoir 16 includes an internal cover 68 placed over the outlet 26 that allows passage of the potable liquid while reducing disturbances within the reservoir 16.

To allow reservoir 16 to be filled, reservoir 16 may define a fill opening 75. To cover the opening 75, reservoir 16 may also include an optional moveable lid 70. The lid 70 includes a graspable area or lid handle 72 and may be freely removed or hingedly opened, as shown in FIG. 8. The reservoir 16 may include a lid mating member 74 for sealing engagement with the lid 70 the mating member 74 may be made of rubber, plastic, silicone of any other suitable material. Additionally, in the case of the dispenser 10 including the reservoir 16, the optional display 34 may indicate any condition of the liquid in the reservoir 16, such as temperature, volume, or particle level.

As shown in FIGS. 8 and 9, the dispenser 10 may include an optional basin filter 76. The basin filter 76 may operate by gravity feed or any other suitable mechanism. In general, basin filter 76 has a profile that conforms to basin 24 to provide a close fit between outlet 26 and basin 24. In the example shown in FIGS. 8 and 9, basin filter 76 is generally conically shaped and extends axially in two sections, an upper section 80 and a lower section 78, with filtration occurring in the upper section 80 and/or lower section 78 as desired.

The upper section 80 may be tapered to fit within the optional basin extension 25 such that, depending upon the chosen configuration the upper section 80 may sealingly engage the basin extension 25 to reduce leakage or spillage or may engage the basin extension 25 to distribute the load of supporting the reservoir 16. Upper section 80 may extend radially outward from lower section 78 to form an annular shoulder 83. As best shown in FIG. 9, shoulder 83 may rest on a lower surface 85 of basin extension 25. In this way, the weight of reservoir 16 may be supported by extension 25.

The upper section 80 includes a passageway 84 that receives outlet 26. The passageway 84 is sized and configured to sealingly engage the reservoir 16 or a conventional liquid reservoir. Basin filter 76 includes a second recess 87 adapted to receive an upstanding drain that extends from housing 14 to pierce a seal of a conventional water bottle. When using basin filter 76, the drain is received in second recess 87 and communicates with basin filter 76, such that the filtered liquid exits filter 76 through the drain and enters the housing 14. Further treatment may be carried out downstream of basin filter 76 before dispensing the liquid from nozzle 46. Thus the basin filter 76 may couplingly engage a variety of housing or reservoirs.

The lower section 78 may also be tapered to fit with the basin of a variety of conventional liquid dispenser and will lower into the basin until firmly engaging the sidewalls thereof. A sealing member 82, such as an o-ring or the like, is disposed about the lower section 78 to provide a sealing arrangement between the basin filter 76 and the basin 24. It will be appreciated that basin filter 76 and basin 24 do not have to be sealingly arranged with respect to one another in the case where the flow of potable liquid is controlled before the point of entry to the basin filter 76.

In operation, a user may refill the reservoir 16 with tap water or any other suitable liquid without having to move reservoir 16 by opening the lid 70. Additionally it must be understood that it is contemplated that the dispenser 10 may operate without a reservoir 16 or supply line 40, but rather by having liquid poured directly into the basin 24. When using a conventional reservoir, standard water bottle or jug a basin filter 76 may be placed in a basin and the bottle or jug placed onto the basin filter 76 or the basin filter 76 may be placed onto the bottle or jug and then the combined basin filter 76 and the bottle or jug placed in the basin.

In any case, once the basin filter 76 is in a basin and liquid is supplied, liquid may flow through the basin filter 76. It must be understood that the unit comprising the basin filter 76 may include one or more actual filters. The liquid then proceeds to through the housing to be used in a conventional manner.

In one embodiment, the basin filter unit is placed in a traditional freestanding or surface top water cooler or liquid dispenser. The associated bottle or jug may already be filled with prepackaged water or other liquid or may be filled with tap water or other potable liquid. The bottle may then be fitted with the filter unit and placed on the water cooler or the filter unit may be placed in the water cooler and the bottle placed on to the filter.

As shown in FIG. 10, dispenser 10 includes a base 12 for supporting the housing 14. The housing 14 is shown in FIG. 10 as supported by the base 12, in the alternative to the housing 14 resting directly on a countertop or tabletop 22 as shown in FIGS. 1 and 2. The desired height of housing 14 for a given application may be achieved by selecting the height of the base 12 as necessary. For example, as shown in FIG. 10, the base 12 may support the housing 14 in a free standing manner. The base 12 may be a cabinet style base that may have open storage space or may include a variety of working components of the dispenser 10. In the example shown, base 12 includes a door 18 with a door handle 20 to provide access to the interior space therein. The interior space of the base 12 may be climate controlled, such as refrigerated, heated or humidity controlled, to function as a refrigerator, warmer or humidor. The base 12 may be made of any suitable material, such as metal, for example stainless steel, or plastic, for example a high density plastic, or wood, glass or any suitable composite material, and may be colored in any desired color, in any suitable manner, such as painting or dying.

While principles and modes of operation have been explained and illustrated with regards to particular embodiments, it must be understood, however, that these may be practiced otherwise than as specifically explained and illustrated without departing from spirit or scope.

What is claimed is:

1. An apparatus for dispensing a potable liquid comprising:
a housing in fluid communication with a source of the potable liquid;
the housing including a cassette receiver;
a cassette unit disposed in the cassette receiver and in communication with the source, the cassette unit being adapted to treat the potable liquid passing there through; and
a nozzle located downstream relative to the cassette unit and in fluid communication therewith, wherein the nozzle is adapted to selectively dispense the potable liquid after it passes through the cassette unit.

2. The apparatus of claim 1 wherein the cassette unit includes one of a filter and a fortifier.

3. The apparatus of claim 1 wherein the housing further includes a basin and the apparatus further comprises a basin filter disposed in the basin for the passage of a potable liquid before passing though the cassette unit.

4. The apparatus of claim 3 wherein the filter is operative to reduce the sedimentary level of at least one of chlorine, copper, mercury, cadmium, and benzene, and leave a significant level of fluoride in the potable liquid passed there through.

5. The apparatus of claim 3 wherein the basin filter includes an outlet coupling for accepting insertion into one of a group of basins of varying size.

6. The apparatus of claim 3 wherein the basin filter includes an inlet coupling for accepting one of a group of reservoirs having outlets of varying size.

7. The apparatus of claim 3 further comprising a reservoir having an outlet disposed within the basin filter.

8. The apparatus of claim 7 wherein the reservoir includes an internal cap that covers the outlet to reduce disturbances within the reservoir.

9. The apparatus of claim 1 wherein the housing configured to rest upon a countertop or tabletop as a surface-top housing, and the apparatus further comprises a freestanding base for supporting the housing.

10. The apparatus of claim 1 wherein the dispenser is operable to dispense a predetermined amount of liquid.

11. The apparatus of claim 10 wherein the dispenser includes a control panel having selectors that are associated with one of a predetermined amount of liquid to be dispensed or a type of container to be filled.

12. The apparatus of claim 11 wherein the selectors include icons to designate the variety of predetermined amounts or types of containers.

13. A potable liquid dispenser comprising:
a housing for the treatment of a potable liquid passing there through, wherein the housing is capable of one of filtering and fortifying the potable liquid and one of heating and cooling the liquid.

14. The dispenser of claim 13 wherein the housing is capable of the other of filtering and fortifying the liquid and the other of heating and cooling the liquid.

15. The dispenser of claim 13 wherein the housing in configured to rest directly on a countertop or a tabletop as a surface-top unit, the dispenser further comprising a base supporting the housing.

16. The dispenser of claim 13 wherein the housing further includes a basin configured for receiving potable liquid from a potable liquid source, the basin including a basin filter for treating the potable liquid.

17. The dispenser of claim 13 wherein the housing further includes a cassette receiver having a cassette unit disposed therein for treating the potable liquid after passage through the basin filter.

18. The dispenser of claim 17 wherein the cassette unit includes one of a filter and a fortifier.

19. The dispenser of claim 18 further comprising a reservoir to provide potable liquid to the basin through the basin filter.

20. The dispenser of claim 19 wherein the housing further includes a basin extension to at least partially support the reservoir.

21. The dispenser of claim 19 wherein the reservoir includes an internal cap disposed over an outlet to the basin filter to reduce disturbances within the reservoir.

22. The dispenser of claim 13 further comprising a reservoir engaging the housing to provide potable liquid, the reservoir including a fill opening for filling the reservoir while engaging the housing.

23. The dispenser of claim 22 wherein the reservoir includes a moveable lid to cover the fill opening.

24. The dispenser of claim 23 wherein the lid is hindgedly connected to a main body of the reservoir.

25. The dispenser of claim 23 wherein the reservoir includes a mating member to provide a sealing engagement between the lid and the fill opening.

26. The dispenser of claim 23 further comprising a basin filter disposed between the fluid communication of the reservoir and the housing.

27. The dispenser of claim 26 wherein the basin filter at least partially supports the reservoir.

28. The dispenser of claim 26 wherein the basin filter includes an annular shoulder resting upon a surface of the housing.

29. The dispenser of claim 26 wherein the basin filter includes at least one tapered section that sealing engages a basin in the housing.

30. The dispenser of claim 13 further comprising a control panel for controlling the treatment functions of the housing.

31. The dispenser of claim 30 wherein the control panel includes selectors chosen from the group consisting of buttons, knobs and switches to control the dispensing potable liquid in accordance with preprogrammed function.

32. The dispenser of claim 31 wherein the control panel is configured for access to a control menu for programming the preprogrammed functions

33. The dispenser of claim 31 wherein the selectors are coded in with one of alpha numeric text or color coding.

34. The dispenser of claim 30 wherein the control panel includes a display for indicating a condition of the potable liquid being dispensed.

35. The dispenser of claim 13 wherein the housing further includes a moveable nozzle for the dispensing of a potable liquid.

36. The dispenser of claim 35 wherein the housing includes a contour to indicate the range of movement of the moveable nozzle.

37. The dispenser of claim 35 wherein the moveable nozzle includes a marker to indicate one of a location and a position of the moveable nozzle.

38. The dispenser of claim 13 further comprising a sump platform for the collection of excess potable liquid.

39. The dispenser of claim 38 wherein the sump platform includes a sump tray for the collection of the excess potable liquid and the sump tray includes a handle for grasp by a user.

40. The dispenser of claim 39 wherein sump tray includes a catch assembly to prevent the sump tray from freely moving relative to the housing.

41. The dispenser of claim 40 wherein the catch assembly includes a groove in the sump tray that cooperates with a stop formed in the housing to limit the movement of the sump tray.

42. The dispenser of claim 40 where the catch assembly includes a portion of the sump tray braced between upper and lower surfaces of a recess formed in the housing.

43. The apparatus of claim 13 wherein the dispenser is operable to dispense a predetermined amount of liquid.

44. The apparatus of claim 43 wherein the dispenser includes a control panel having selectors that are associated with one of a predetermined amount of liquid to be dispensed or a type of container to be filled.

45. The apparatus of claim 44 wherein the selectors include icons to designate the variety of predetermined amounts or types of containers.
